(19) United States
(12) Patent Application Publication
(10) Pub. No.: US 2011/0091030 A1
(43) Pub. Date: Apr. 21, 2011

(54) DYNAMIC CALLBACKS FROM A CONTACT CENTER

(76) Inventors: Raghurama Bhat, Cupertino, CA (US); Mukul Jain, San Jose, CA (US); Joseph F. Khouri, San Jose, CA (US)

(21) Appl. No.: 12/580,716

(22) Filed: Oct. 16, 2009

(51) Int. Cl. H04M 3/50

(52) U.S. Cl. 379/265.09

(57) ABSTRACT

A contact center is provided. The contract center may include an input and a processor. The input is operable to receive communication from a first contact media type. The processor is operable to respond to communication from the first contact media type by initiating communication with a second contact media type, the first and second contact media types being associated with a contact and the first contact media type being different from the second contact media type.

### FIELD

The present embodiments relate to contact centers. In particular, the present embodiments may relate to dynamically responding to a contact.

### BACKGROUND

Contact centers may be used to receive and/or distribute communication, such as phone calls or emails, from contacts. In some cases, for example, when the contact center is a call center and is operated by a business, a contact may be an actual or potential customer calling with an inquiry or complaint. The contact center may place the contact on hold until an agent becomes available to assist with the inquiry or complaint. In order to provide excellent customer service, the contact center should minimize the frustration, delay, or hold time for the contact.

### BRIEF DESCRIPTION OF THE DRAWINGS

FIG. 1 illustrates one example of a contact center system;

FIG. 2 illustrates another embodiment of a contact center system;

FIG. 3 illustrates yet another embodiment of a contact center system; and

FIG. 4 illustrates one embodiment of a method for responding to a contact.

### DETAILED DESCRIPTION

The present embodiments relate to contact centers that dynamically respond to contacts. Contacts may be humans or programmed electronic machines that interact with a contact center using contact media types. Media types may be media devices and/or media services, such as phones, messaging services, video services, etc. Agents may be humans or programmed electronic machines that support the contact center using agent media types. The agents may be employed by the contact center, for example, to answer inquiries or record complaints. The contact center may be operable to match (e.g., connect) a contact with an agent.

In the event that one, some, or all of the agents are unavailable when the contact initiates interaction with the contact center, the contact may be provided with an option to wait on the line (e.g., be placed on hold) or be contacted (e.g., called back) when an agent becomes available. When the contact chooses to be contacted, the contact center may select an agent based on the contact media type associated with the contact. The contact media type may periodically or continuously change based on contact information, such as the contact's availability, presence, location, calendar, or status. As a result, the contact center may dynamically select an agent that is able to provide optimal service to the contact by responding to the contact using a media type available to the contact.

In one illustration, a clothing company uses a contact center to match customers with customer service representatives. Customer A has a question regarding a recent bill. Prior to leaving for work, customer A calls a toll-free number for the clothing company from customer A's home phone. The clothing company's contact center informs customer A that there is an approximate wait time of 15 minutes. However, the contact center may provide customer A with the option of being called back when an agent becomes available. Since customer A must leave for work in 5 minutes, customer A chooses to be called back. Once an agent becomes available, the agent or call center may call customer A on customer A's cellular telephone or work phone depending on customer A's location or availability. For example, the call center may call the cellular telephone when customer A is in route from work. As another example, the call center calls back within 2 minutes, so calls the work phone for customer A. The contact center may automatically determine customer A's location by communicating with one or more communication servers, such as a cellular server. The present embodiments relate to responding to customer A using a media type that is available to customer A.

In one aspect, a contact center is provided. The contact center includes an input and a processor. The input is operable to receive communication from a first contact media type. The processor is operable to respond to communication from the first contact media type by initiating communication with a second contact media type. The first and second contact media types may be associated with a contact. The first contact media type may be different from the second contact media type.

In another aspect, a method for responding to a contact is provided. The method may include receiving a first communication from a contact using a first contact media device, terminating the first communication from the first contact media device, and determining a response contact media type based on contact availability information for the contact. The response contact media device may be a second, different, contact media device. The method may also include transmitting a contact center response ticket that initiates a second communication with the response contact media type.

In yet another aspect, logic encoded in one or more tangible media for execution is provided. The logic may executed to receive communication from a first contact media type, terminate communication from the first contact media type, and respond to communication from the first contact media type by initiating communication with a second contact media type. The first and second contact media types may be associated with a contact. The first contact media type may be different from the second contact media type.

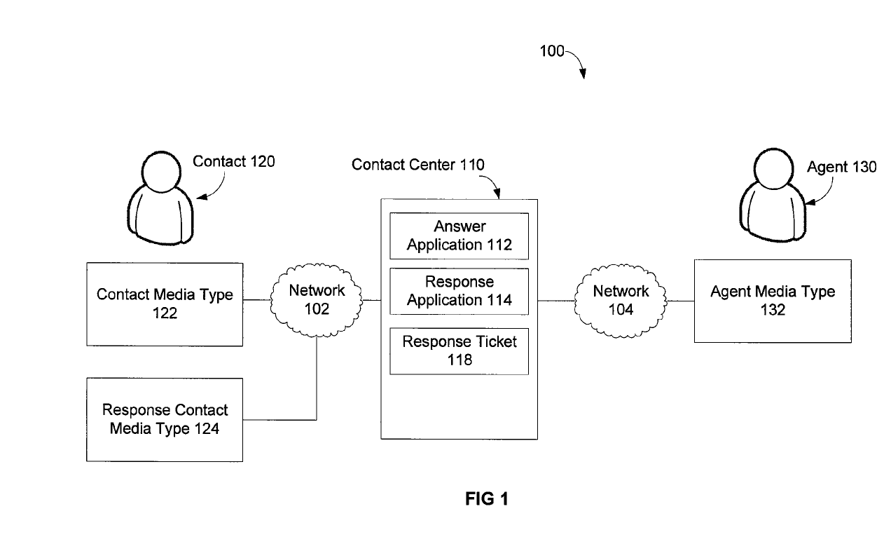

FIG. 1 illustrates a contact center system 100 for managing one or more contacts using a contact center. The contact center system 100 may include a contact center 110, one or more contacts 120 (hereinafter, contact 120), and one or more agents 130 (hereinafter, agent 130). The contact 120 may manage, operate, own, control, and/or use one or more contact media types 122 and/or response contact media types 124. The agent 130 may manage, operate, own, control, and/or use one or more agent media types 132. The contact center 110 may be coupled with the one or more contact media types 122 via a network 102 and/or coupled with the one or more agent media types 132 via a network 104. As used herein, “coupled with” includes directly connected or indirectly connected through one or more intermediary components. Intermediary components may include hardware, software, or a combination thereof.

Media includes text, audio, video, and/or graphics. A media type may include a media device and/or a media service. Exemplary media devices include public switched telephone network (PSTN) telephones, cellular telephones, video conferencing systems, voice over Internet Protocol (VoIP) systems, email servers, and personal computers. Exemplary media services include instant messaging, media message service (MMS), short message service (SMS), email service, and picture messaging.

The networks 102, 104 may each include one or more networks, such as public switched telephone networks (PSTN), the Internet, voice over Internet Protocol (VoIP) networks, cellular telephone networks, a combination thereof, or other communication networks. The networks 102, 104 may provide the contact center, contact media type, and/or agent media type with the ability to communicate using different types of networks. Accordingly, a plurality of different types of networks may be used. The type of network 102, 104 may depend on the media type being used by the agent 130 and/or contact 120. For example, the network 102 may be a PSTN or TCP/IP computer network when the contact media type 122 is an office phone. In another example, the network 102 may include the Internet when the agent media type 132 is an email server.

The contact center 110 may be a call center, contact interaction center, e-contact center, or other hub that manages communication from the one or more contacts 120. Communication may include calls, messages, video, or combinations thereof. The messages may be text messages (e.g., email messages, SMS messages), image messages (e.g., MMS messages), or the combination thereof. The contact 120 may initiate communication with the contact center, for example, by placing a phone call or sending a media message. The contact center 110 may receive the communication, for example, by accepting a phone call or receiving a media message.

The contact center 110 may use an answer application 112 to receive communication from a contact 120. The answer application 112 may be used to determine whether to place the contact 120 on hold or execute a response application 114 stored in the contact center 110. In one embodiment, the answer application 112 may use an interactive voice response (IVR) system to interact with the contact 120. The IVR system may be stored in the contact center 110. The IVR system may automate the personal interaction of telephone callers with a computerized phone system. The IVR system may use voice recorded prompts and menus to present information to callers. Touch-tone telephone keypad entries or verbal commands/questions are gathered from the contact 120 to collect information and to provide navigation through simple to complex IVR menu structures. For example, the IVR system may play an automated message commanding the contact 120 to press “1” in the event that the contact 120 wants to be placed on hold and to press “2” in the event that the contact 120 wants to be called back when an agent 130 is available. The contact media type 122 may be used to enter a “1” or “2,” for example, using a touch tone pad. Alternatively, the IVR system 114 may detect voice commands from the contact 120, such as “hold” or “call back.” Other interaction with the IVR system may be used. In other embodiments, a visual prompt is provided, such as allowing the user to select between options in a computer or video conference user interface environment.

The response application 114 may be used to dynamically respond to a contact 120. The response application 114 may be used as an alternative to placing the contact 120 on hold. When the contact 120 is placed on hold, the communication between the contact media type 122 and the contact center 110 is maintained, for example, without terminating the communication. In other words, the contact 120 is still on the line. The response application 114 may be executed to dynamically respond to a contact 120 when the communication has been terminated.

When an agent 130 becomes available, the response application 114 may dynamically respond to the contact 120. This is advantageous because the contact 120 is no longer required to wait while an agent 130 becomes available. This frees up the contact's time and resources, such as cell phone minutes. The response may be, but is not limited to, a phone call, email, SMS message, MMS message, VoIP call, video-conference, Web conference, or other media. Depending on the type of response, the response application 114 may be referred to as a call back application, text response application, or other application for responding to a contact instead of placing an on-line contact on hold.

When executed, for example, by a contact center processor, the response application 114 may determine a response contact media type and initiate communication between the contact 120 and available agent 130. The response contact media type 124 may be a contact media type that is to be used when responding to the contact 120. The response contact media type 124 may be the same or different media type as the contact media type 122 used to originally communicate with the contact center 110. For example, the contact 120 may have called the contact center 110 using an office phone, but the response contact media type 124 may be a cellular phone, instant messaging service, short message service message, or email. In another example, both the contact media type 122 and response contact media type 124 are the office phone.

The contact center 110 may periodically, continuously, or as needed determine the response contact media type 124. The response contact media type 124 may be determined based on data input into the contact center 110, data stored in memory, contact information, or other information provided to the contact center. For example, the contact 120 may determine the response contact media type 124 using the interactive voice response (IVR) system. The contact 120 may use the IVR system to identify a response contact media type 124. In the illustration above, customer A may define the cellular telephone as the response contact media type 124. The IVR system may also be used to input information about the response contact media type 124, for example, phone number or messaging identification. The contact center 120 may retrieve information about the response contact media type 124 from memory. The response contact media type 124 may be different for different times. These limitations may be provided to the contact center 120.

In another example, the contact center 110 may determine the response contact media type 124 based on contact information. Contact information may be information about the contact 120. For example, contact information may indicate how to respond to the contact 120, an availability of the contact 120, when to respond to the contact 120, a location of the contact 120, an account number associated with the contact 120, a topic that the contact 120 would like to discuss or has questions about, etc. The contact information may be previously provided by the contact outside of the context of the current interaction. The contact information may be publically available information, such as mined from a computer, as an availability server or personal computer. The contact information may be corporate information, such as where the contact is an employee of the company operating the contact center 110. The contact center 110 may select a response contact media type 124 based on the contact information.

In one embodiment, the contact center 110 may gather contact information from one or more availability servers. Availability server may be personal computers, central servers, email servers, Internet servers, social networking service servers, Intranet servers, calendar servers, corporate security servers, global positioning system servers, or other servers that may be used to provide or determine the contact's availability, presence, location, calendar, or status. In one example, when the contact 120 is in route to work, the contact center 110 may receive contact information defining the contact's 120 location. The contact's location may be defined using the contact's global positioning system (GPS)-enabled mobile device and a GPS server. In another example, when the contact 120 is at the office, the contact center 110 may receive contact information defining the contact is in a conference room and does not have access to the office phone. The contact information may be gathered from a security access card system at the contact 120's employer or an internal location detection system. In yet another example, when the contact 120 is in a meeting, the contact center 110 may receive contact information defining the contact's availability using an availability server, such a calendar server.

In order to determine the response contact media type 124, the contact center 110 may use one or more policies. The policies may be a set of one or more rules and definitions. The one or more policies may be manually or automatically defined by a user, contact, system administrator, contact center 110, or other electronic policy system. The one or more policies may be weighted relative to each other. The policies may be hierarchical in nature. In other embodiments, the policies are rules or thresholds set to represent differences in chance rather than an actual level.

The contact center 110 may compare contact information to the one or more policies to determine the response contact media type 124. In one example, a contact 120 may update a status on a social networking service, such as Facebook®, MySpace®, or Twitter®. A social networking server may transmit contact information, indicating the updated status, to the contact center 110. The contact information (i.e., the updated status) may be compared to one or more policies. One of the policies may be: “If status is “at home,” then the response contact media type 124 is a home telephone.”

In another example, contact 120 may use a global positioning system (GPS)-enabled mobile device. A GPS server may transmit the contact's location to the contact center 110. The contact's location may be compared to one or more location policies. One of the policies may be: “If location is “location A,” then the response contact media type 124 is a cellular telephone.”

In yet another example, a contact 120 may swipe a company badge to enter Building X. A security system at Building X may transmit contact information, indicating that the contact 120 is in Building X, to contact center 110. The contact information (i.e., that the contact 120 is in Building X) may be compared to one or more policies. One of the policies may be: “If contact 120 is in Building X, then the response contact media type 124 is an office phone.”

In yet another example, a contact 120 may update an electronic calendar to indicate that from 9:00-10:00am the contact 120 will be in Conference Room A for a meeting. The contact center 110 may receive contact information, defining the calendar event, from an availability server supporting the calendar. The contact information may be compared to one or more policies. One of the policies may be: “If in a meeting, then the response contact media type 124 is email.”

A combination of policies may be used by the contact center 110. In one embodiment, the contact center 110 may use override policies or exception policies. In the Building X and Conference Room A examples above, conference room A may be in Building X. Accordingly, while the contact 120 is in Building X, the response contact media type 124 is the office phone; however, when the contact 120 is in a meeting, even if it is in Building X, the response contact media type 124 is email.

In another embodiment, the policies may be weighted. One policy may be given more weight than another policy. Weights may include rankings or preference. A policy with a greater weight may override a policy with a lower weight. The weightings of the policies may be combined. For example, three policies may be used to determine the level of accessing a contact 12 via an office phone. The first policy may have a weight of “10”, the second policy may have a weight of “4”, and the third policy may have a weight of “5”. The weightings may be aggregated to determine the aggregated level. In this example, the first policy may outweigh the aggregation of the second and third policies (i.e., 10 is greater than 7).

The contact center 110 may be operable to dynamically determine the response contact media type 124. Dynamically adjusting the response contact media type 124 may include changing the response contact media type 124 as contact information is received or changes. The contact center 110 may adjust the response contact media type 124 dynamically, periodically, continuously, or as a rule. For example, the contact center 110 may adjust the response contact media type 124 each time predefined contact information is received or changes, such as when the contact center 110 detects an operation status change or availability change.

The following examples illustrate additional examples of policies that may be used to dynamically determine the response contact media type 124. The examples may be combined or used alone.

Example 1: If the contact 120 is logged out of all instant messaging types and all email messaging services, then the response contact media type 124 is the office telephone.

Example 2: If the contact 120 has forwarded an office phone to voicemail, then the response contact media type 124 is a cellular telephone or email.

Example 3: If the contact 120 is not logged in or connected to a video client, then the response contact media type 124 an office telephone.

Example 4: If the contact 120 is logged into an instant messaging client but is busy on the phone or in a meeting, then the response contact media type 124 is an instant messaging service.

Example 5: If the contact 120 is in a meeting, for example, as specified in an electronic calendar, then the response contact media type 124 is email.

Example 6: During non-working hours (e.g., as specified by the contact 120 or a company), the response contact media type 124 is a home telephone.

Example 7: If the contact 120 is logged into a phone and IM client but is in a “Do Not Disturb Mode,” then response contact media type 124 is email.

Example 8: If the contact 120 is logged into an office phone and is not “On the Phone” or “In a Meeting,” then the response contact media type 124 may be an office telephone.

Once the contact center 110 determines the response contact media type 124, the contact center 110 may initiate communication between an agent media type 132 and the response contact media type 124. The contact center 110 may initiate communication when the agent 130 is available to respond to the contact 120. In other words, the communication may be adjusted to a time when the contact 120 is available. For example, if the contact 120 is in a meeting, the contact center 110 may initiate communication when the contact 120 is scheduled to be out of the meeting, or shortly thereafter.

Initiating communication may include generating a response ticket 118 for the contact 120. The response ticket 118 may indicate that contact 120 is waiting for a response. The response ticket 118 may be broadcast to one or more agents 130. One or more agents 130 may accept the response ticket 118. Once accepted, the agent 130 may be assigned the responsibility of initiating communication with the contact 120. The agent 130 may use the response ticket 118 to establish a connection between the agent media type 132 and the response contact media type 124. For example, the response ticket 118 may define the response contact media type 124 and associated address or contact information (e.g., phone number). Alternatively, or additionally, the response ticket 118 may include information about the contact 120, for example, a name or customer number. The agent 130 may retrieve a contact record. The contact record may define the response contact media type 124 and/or information about the response contact media type 124, such as a phone number, etc. In other embodiments, the contact center 110 established communication between the agent 130 and the contact 120 automatically in response to acceptance of the response ticket 118 by the agent 130.

The response ticket 118 may be broadcast based on the response contact media type 124. The response ticket 118 may be broadcast to a group of agents 130 that are able to respond to the response contact media type 124. For example, in the event that the response contact media type 124 is a cellular telephone, the contact center 110 may broadcast the response ticket to a group of agents 130 that are able to call the cellular telephone. The contact center 110 may not broadcast the response ticket 118 to agents 130 that are not able to call the cellular telephone. Other broadcasting techniques, such as broadcasting based on knowledge, skills, availability, or schedules, may be used.

The agent 130 may initiate communication with the contact 120 using the agent media type 132. The communication may be direct communication or indirect communication. For example, in one embodiment, the contact center 110 may connect the agent media type 132 with the response contact media type 124 via the contact center 110. In another embodiment, the agent media type 132 may communicate with the response contact media type 124 independently of the contact center 110, for example, via network that is not coupled with the contact center 110.

Initiating communication with the contact 120 may include responding to the contact 120. Responding to the contact 120 may include calling, emailing, SMS messaging, MMS messaging, VoIP calling, video-conferencing, or other communication. For example, upon receiving and accepting the response ticket 118, the agent 130 may use the agent media type 132 to call the response contact media type 124.

Responding to the contact 120 may be based on the contact's availability. The contact's availability may be determined using an availability server or availability information stored or received by the contact center 110. The contact's availability may be based on the contact's calendar, location, presence, or status. For example, in the event that the contact 120 is in a meeting from 2:00pm-3:00pm, the agent 130 may wait until 3:30pm to respond to the contact 120. Accordingly, responding to the contact 120 may be tailored to responding at a convenient and appropriate time for the contact 120.

The agent 130 may initiate communication with another response contact media type 124, for example, as a follow up, confirmation, or alternative. In one example, although the response contact media type 124 may be a cellular telephone, the contact 120 may be unable to answer a phone call at the time the agent 130 responds to the contact 120. Accordingly, the agent 130 may transmit an email to the contact 120 using a second response contact media type 124. The second response contact media type 124 may be a backup response contact media type. The agent 130 may initiate communication with any number of response contact media types.

The contact center 110 may include a processor and memory. The processor may be a general processor, digital signal processor, application specific integrated circuit, field programmable gate array, analog circuit, digital circuit, combinations thereof, or other now known or later developed processor. The processor may be a single device or a combination of devices, such as associated with a network or distributed processing. Any of various processing strategies may be used, such as multi-processing, multi-tasking, parallel processing, remote processing, or the like. The processor is responsive to instructions stored as part of software, hardware, integrated circuits, firmware, micro-code or the like.

The memory may be computer readable storage media. The computer readable storage media may include various types of volatile and non-volatile storage media, including, but not limited to, random access memory, read-only memory, programmable read-only memory, electrically programmable read-only memory, electrically erasable read-only memory, flash memory, magnetic tape or disk, optical media and the like. The memory may be a single device or a combination of devices. The memory 420 may be adjacent to, part of, networked with and/or remote from the processor.

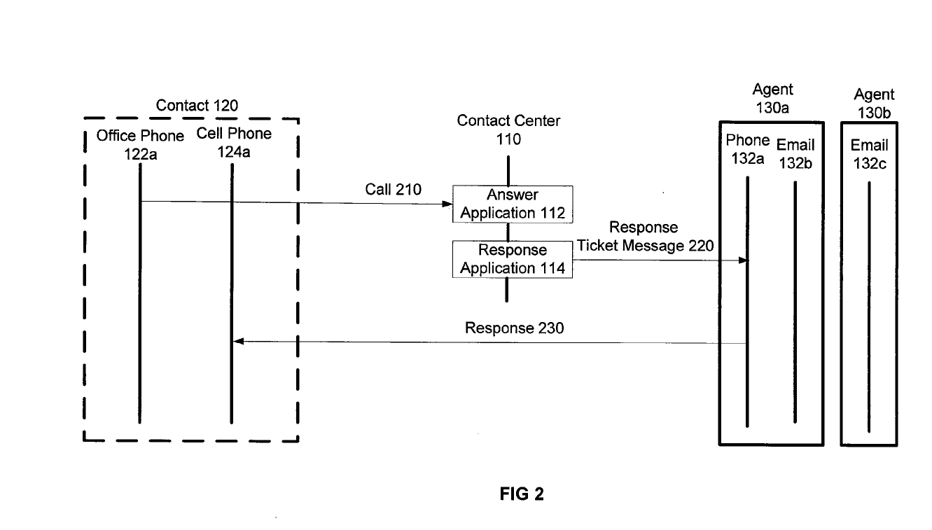

FIG. 2 illustrates an example of dynamically responding to a contact 120. FIG. 2 illustrates an example of when the contact 120 uses an office phone 122a to call 210 the contact center 110. At the time of call 210, the contact 120 was in the office. The contact center 110 uses the answer application 112 to receive the call 210. The contact center 110 may determine that all agents are busy or unavailable. The contact center 110 may determine that the contact 120 desires to be contacted when an agent 130 becomes available. Accordingly, the call 210 is terminated and the response application 114 is initiated. At some time after termination of the call 210, the contact center 120 may determine that agent 130a and agent 130b are available. The contact center 110 may transmit a response ticket message 220 to only agent 130a, for example, via a text message, because agent 130b does not have phone capabilities or does not prefer to use the phone. Alternatively, the contact center 120 may broadcast a response ticket 220 to agents 130a and 130b. The response ticket message 220 may include a response ticket 118. The response ticket message 220 may include a response contact media type 124 for the contact 120. Since termination of the call 210, the response contact media type 124 changed from office phone 122a to cell phone 124a, for example, based on the contact 130 no longer having access to the office phone 122a. The response contact media type 124 may be defined in the response ticket 118. Alternatively, the response contact media type 124 may be defined in a database or received from an availability server. Agent 130a may receive and accept the response message 220 and use the phone 132a to respond 230 to contact 120. The response 230 may be a phone call to the contact's cell phone 124a.

The response contact media type 124 may dynamically change. The response contact media type 124 may change as contact information changes. The response contact media type 124 may change before, or after the termination of the original communication. For example, in the event that a contact 120 leaves the office, the response contact media type 124 associated with the contact 120 may be switched from an office phone 122a to a cell phone 122b. The response contact media type 124 may be updated continuously or periodically. The response contact media type 124 may be updated based on the contact's availability, presence, preferences, calendar events, location, or status.

The contact center 110 may gather contact information and change the response contact media type 124 based on the gathered contact information. Accordingly, the contact center 110 may adapt to the changing circumstances of the contact 120. As the circumstances of the contact, for example, the contact's location, schedule, or availability change, the contact center 110 may alter the interaction between the contact center 110, contact 120, one or more agents 130, or a combination thereof. Altering the interaction may include responding to the contact 120 using an optimal contact media type 122. An optimal contact media type 122 may be a media type 122 that is available to the contact 120.

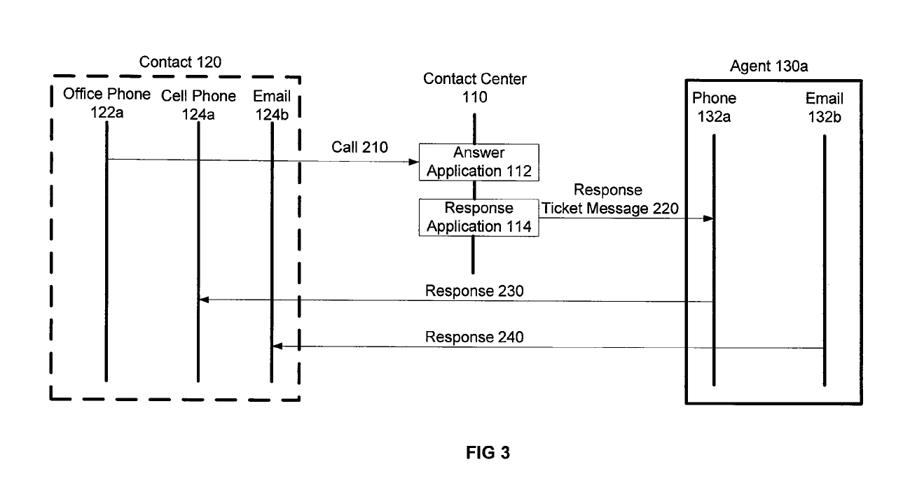

FIG. 3 illustrates one embodiment of dynamically responding to a second response media contact type 124b. As shown in FIG. 3, after the response 230, as was described in FIG. 2, the agent 130a may respond 240 to a second response media contact type 124b. In other words, the agent 130a may use an email service to send an email to the contact 120. The response 240 may be a confirmation or follow up from response 230. Alternatively, the response 240 may be a result of the response 230 not being connected, answered, or accepted. In one embodiment, the agent 130 may initiate communication with the contact media type 122a, as an alternative to initiating communication with a response contact media type 124.

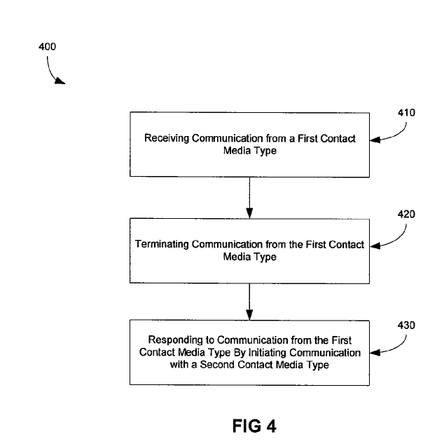

FIG. 4 illustrates one embodiment of a method for dynamically responding to a contact. The method includes receiving communication from a first contact media type 410; terminating communication from the first contact media type 420; and responding to communication from the first contact media type by initiating communication with a second contact media type 430. The first and second contact media types may be associated with a contact and the first contact media type may be different from the second contact media type.

In act 410, a contact center may receive communication from a first contact media type. Receiving communication may include receiving a phone call, email, message, or other type of communication. For example, the communication may be a phone call. The contact center may determine whether the contact desires to wait on the line using the first contact media type until an agent becomes available or desires to be contacted when an agent becomes available. Alternatively, the contact center may only provide the option of contacting the contact when an agent becomes available.

In act 420, communication from the first contact media type may be terminated. The contact center or first contact media type may terminate communication. The communication may be terminated when the contact desires to be contacted. Otherwise, the first contact media type may remain on the line and wait for an agent to become available.

In act 430, the contact center may respond to the initial communication by initiating a response communication. The response communication uses the first (i.e., same as the initial communication) contact media type or a second contact media type. When responding to the communication, the contact center may determine the contact media type based on contact information. The contact information may include information about the contact's availability, presence, location, calendar, or status. As a result, the contact center may dynamically respond to a media type that is available or convenient for the contact. A default to the same contact media type used for the initial communication may be used. A priority ranking may be used where different factors are considered to select an optimal media type.

Responding to communication may include calling, emailing, SMS messaging, MMS messaging, VoIP calling, video-conferencing, or other communication. The contact center may periodically or continuously determine a second contact media type and distribute a response ticket to one or more agents that are able to initiate communication with the second contact media type. In one embodiment, the contact center is operable to select an agent that is able to initiate communication with the second contact media type. Initiating communication includes responding to the second contact media type. In one embodiment, receiving communication from the first contact media type may include receiving a telephone call from a first telephone and responding to communication includes calling a second telephone.

In another embodiment, the method may include dynamically responding to a third contact media type. The third contact media type may be the same or different than the first and second contact media type. The contact center may initiate communication with the third contact media type as a confirmation or follow up. Alternatively, the contact center may initiate communication with the third contact media type when the second contact media type is not available.

Various embodiments described herein can be used alone or in combination with one another. The foregoing detailed description has described only a few of the many possible implementations of the present invention. For this reason, this detailed description is intended by way of illustration, and not by way of limitation.

1. A contact center comprising:
an input operable to receive communication from a first contact media type; and
a processor that is operable to respond to communication from the first contact media type by initiating communication with a second contact media type, the first and second contact media types being associated with a contact and the first contact media type being different from the second contact media type.

2. The contact center as claimed in claim 1, wherein the input is operable to receive contact information that defines the contact's availability, schedule, preferred contact media type, location, or a combination thereof.

3. The contact center as claimed in claim 2, wherein the processor is operable to select the second contact media type based on the contact information.

4. The contact center as claimed in claim 3, wherein the processor is operable to transmit a response ticket to an agent supporting the second contact media type and the agent is operable to initiate communication with the second contact media type.

5. The contact center as claimed in claim 1, wherein the processor is operable to initiate communication with the second contact media type after termination of the communication from the first contact media type.

6. The contact center as claimed in claim 1, wherein the contact information defines the availability of the contact to the first contact media type as not available and the availability of the contact to the second contact media type as available.

7. The contact center as claimed in claim 1, wherein the first contact media type is a first telephone and the second contact media type is a second telephone, text message service, or image message service.

8. A method for responding to a contact, the method comprising:
receiving a first communication from a contact using a first contact media device;
terminating the first communication from the first contact media device;
determining a response contact media type based on contact availability information for the contact, the response contact media device being a second, different, contact media device; and
transmitting a contact center response ticket that initiates a second communication with the response contact media type.

9. The method as claimed in claim 8, wherein determining the response contact media type includes determining the response contact media type based on contact information that may be compared to an availability policy that defines the response contact media type that is accessible to the contact.

10. The method as claimed in claim 8, wherein transmitting the contact center response ticket includes broadcasting the contact center response ticket to one or more contact center agents that are able to initiate communication with the response contact media type.

11. The method as claimed in claim 8, further comprising responding to the contact using the response contact media type.

12. The method as claimed in claim 8, further comprising receiving additional contact availability information for the contact and changing the response contact media type based on the additional contact availability information.

13. The method as claimed in claim 8, further comprising selecting a backup response contact media type based on the contact availability information.

14. The method as claimed in claim 8, wherein receiving communication from the first contact media type includes receiving a telephone call from a first telephone and responding to communication includes calling a second telephone.

15. Logic encoded in one or more tangible media for execution and when executed operable to:
receive communication from a first contact media type;
terminate communication from the first contact media type; and
respond to communication from the first contact media type by initiating communication with a second contact media type, the first and second contact media types being associated with a contact and the first contact media type being different from the second contact media type.

16. The logic as claimed in claim 15, wherein the logic is executable to determine the second contact media type based on contact information that defines a media type that is accessible to a contact when responding to the communication.

17. The logic as claimed in claim 15, wherein the logic is executable to determine the second contact media type and distributing a response ticket to one or more agents that are able to initiate communication with the second contact media type.

18. The logic as claimed in claim 15, wherein the logic is executable to select an agent that is able to initiate communication with the second contact media type.

19. The logic as claimed in claim 15, wherein the logic is executable to receive a telephone call from a first telephone and responding to communication includes calling a second telephone.

20. The logic as claimed in claim 15, wherein the first contact media type is a different media type than the second contact media type.
